(19) United States
(12) Patent Application Publication
(10) Pub. No.: US 2009/0177447 A1
(43) Pub. Date: Jul. 9, 2009

(54) Method for Estimating Software Development Effort

(75) Inventors: Chao Jung Hsu, Hsinchu (TW); Chin Yu Huang, Taipei County (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, Hsinchu (TW)

(21) Appl. No.: 11/969,579

(22) Filed: Jan. 4, 2008

(51) Int. Cl. G06F 17/10; G06F 17/15; G06F 7/38

(52) U.S. Cl. 703/2; 708/422; 708/523

(57) ABSTRACT

A method for estimating software development effort comprises the steps of: generating a database containing a plurality of source softwares; calculating the Grey relational coefficients between the software to be developed and a source software in the database for each feature they exhibit; calculating the weights for each Grey relational coefficient; multiplying each Grey relational coefficient with the corresponding weight; calculating the Grey relational grade by summing up the products produced in the multiplying step; calculating the Grey relational grades for all remaining source softwares in the database; and comparing the Grey relational grades to estimate the effort for developing the software to be developed.

### BACKGROUND OF THE INVENTION

(A) Field of the Invention

The present invention relates to a method for estimating software development effort, and more particularly, to a method for estimating software development effort by weighted Grey relational analysis.

(B) Description of the Related Art

As the demand for high quality software grows, it becomes more and more important to provide sufficient resources throughout the software development life cycle. That is, the software developer needs to estimate the software development effort before the development process begins. Underestimating the effort needed for software development may lead to a sacrifice in software development or even result in the failure of the software project. In contrast, overestimating the software development effort may cause an inefficient usage of allocated resources and thereby lose the chance of winning the software project during the price bidding process. Therefore, it is necessary to accurately estimate the software development effort required during the software development life cycle.

One of the most widely used methods is the similarity-based method, based on distance comparison of the features or the effort drivers between the current project and the previously completed ones to estimate the software development effort. Grey relational analysis (GRA), which can be seen as one type of the similarity-based methods, has been extensively used in many scientific fields. However, GRA has rarely been applied to the software development effort estimation. Unlike traditional distance based estimating methods, GRA utilizes only a small amount of known data to establish the estimated model. Therefore, one can estimate the software development effort and manage the software project efficiently by applying the GRA method.

Nevertheless, none of the GRA methods utilized thus far consider weighted similarity in predicting software development effort. However, since each effort driver has a different degree of relevance to the effort of software development, ignoring the weights of each effort driver may cause significant downgrade of the current project. Therefore, it is necessary to utilize the weighted GRA method for software development effort estimation.

### SUMMARY OF THE INVENTION

A method for estimating software development effort, wherein the software to be developed exhibits a plurality of features, the method comprising the steps of: generating a database containing a plurality of source softwares, wherein each source software exhibits a plurality of features; calculating the Grey relational coefficients between the software to be developed and a source software in the database for each feature they exhibit, wherein the Grey relational coefficients represent the similarity between the software to be developed and the source software exhibiting the specific feature; calculating the weights for each Grey relational coefficient; multiplying the Grey relational coefficients with the corresponding weights; calculating the Grey relational grade by summing up the products produced in the multiplying step, wherein the Grey relational grade represents the similarity between the software to be developed and the source software; calculating the Grey relational grades for all the remaining source softwares in the database; and comparing the Grey relational grades to estimate the effort for developing the software to be developed.

### BRIEF DESCRIPTION OF THE DRAWINGS

The objectives and advantages of the present invention will become apparent upon reading the following description and upon reference to the accompanying drawings in which:

FIG. 1 shows a flow chart of the present invention for estimating software development effort.

### DETAILED DESCRIPTION OF THE INVENTION

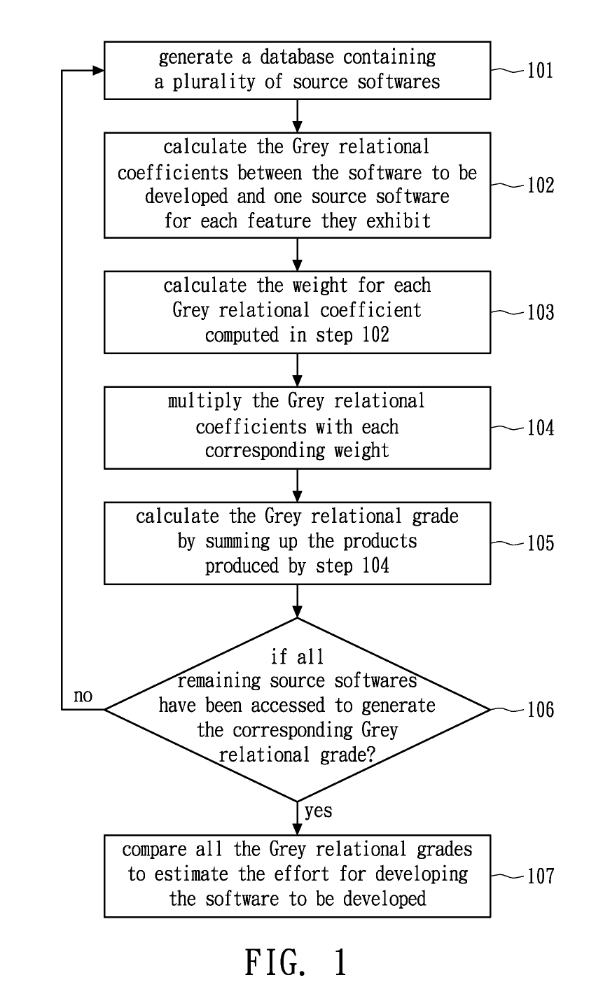

FIG. 1 shows the flow chart of the present invention of the method for estimating software development effort, wherein the software to be developed exhibits a plurality of features. In step 101, generate a database containing a plurality of source softwares, wherein each source software exhibits a plurality of features. In step 102, calculate the Grey relational coefficient between the software to be developed and one source software for each feature they exhibit, wherein the Grey relational coefficient represents the similarity between the software to be developed and the source software exhibiting the specific feature. In step 103, calculate the weight for each Grey relational coefficient computed in step 102. In step 104, multiply the Grey relational coefficients with each corresponding weight. In step 105, calculate the Grey relational grade by summing up the products produced by step 104, wherein the Grey relational grade represents the similarity between the software to be developed and the source software. In step 106, check to see if all remaining source softwares have been accessed to generate the corresponding Grey relational grade. If not all remaining source softwares have been accessed, go back to step 101 and repeat steps 101 to 105 for another source software. If all remaining source softwares have been accessed, then go to step 107. In step 107, compare all the Grey relational grades to estimate the effort for developing the software to be developed. That is, the source software with the highest Grey relational grade represents the software most similar to the software to be developed.

The grade relational coefficients calculated in step 102 are computed by the following equation:

$$γ ( {X}_{0} ( k ) , {X}_{i} ( k ) ) = \frac{min {Δ}_{0 i} + ζ max {Δ}_{0 i}}{{Δ}_{0 i} ( k ) + ζ max {Δ}_{0 i}} ,$$

wherein X₀ denotes the software to be developed, Xᵢ denotes the source software, γ(X₀(k), Xᵢ(k)) denotes the Grey relational coefficient, ζ denotes a coefficient ranging from 0 to 1, k denotes the specific feature in the Grey relational coefficient, X(k) denotes the value of the feature k, Δ₀ᵢ(k) is calculated according to the following equation:

$${Δ}_{0 i} ( k ) = \{ \begin{matrix}\vert {X}_{0} ( k ) - {X}_{i} ( k ) \vert , & if {X}_{0} ( k ) and {X}_{i} ( k ) are numericals \\ 1 , & \begin{matrix}if {X}_{0} ( k ) and {X}_{i} ( k ) are categoricals \\ and {X}_{0} ( k ) \neq {X}_{i} ( k )\end{matrix} \\ 0 , & \begin{matrix}if {X}_{0} ( k ) and {X}_{i} ( k ) are categoricals \\ a nd {X}_{0} ( k ) = {X}_{i} ( k ) ,\end{matrix}\end{matrix}$$

wherein min Δ₀ᵢ is calculated as

$$min {Δ}_{0 i} = {∀}^{min} i {∀}^{min} k \vert {X}_{0} ( k ) - {X}_{i} ( k ) \vert ,$$

and max Δ₀ᵢ is calculated as

$$max {Δ}_{0 i} = {∀}^{max} i {∀}^{max} k \vert {X}_{0} ( k ) - {X}_{i} ( k ) \vert .$$

The Grey relational grades in step 105 are calculated according to the following equation:

$${Γ}_{0 i} = {\sum }_{k = 1}^{M} {β}_{k} γ ( {X}_{0} ( k ) , {X}_{i} ( k ) ) ,$$

wherein Γ₀ᵢ denotes the Grey relational grade, X₀ denotes the software to be developed, Xᵢ denotes the source software, γ(X₀(k), Xᵢ(k)) denotes the Grey relational coefficient, k denotes the feature in the Grey relational coefficient, βₖ denotes the weight corresponding to the feature k, and M is the total number of features.

The criteria for assigning the weights βₖ can be numerous. One criterion is to assign the weights according to the dissimilarity between the feature under consideration and a known effort. That is, if the distance between one feature and a dependent variable, i.e., the known effort, is close, one should expect that the relation of these two variables be highly related. The weights following this criterion are calculated according to the following equation:

$${β}_{k} = \frac{\frac{1}{Distance ( k )}}{{\sum }_{all k} \frac{1}{Distance ( k )}} ,$$

wherein βₖ denotes the weight corresponding to the feature k, and Distance(k) is determined as follows:

$$Distance ( k ) = \sqrt{{\sum }_{i = 1}^{N} {( {X}_{i} ( k ) - {X}_{i} ( Dep ) )}^{2}} ,$$

wherein N denotes the total number of source softwares in the database, and X(Dep) denotes the known effort. Note that the equation for Distance(k) is a kind of Euclidean distance. Accordingly, more influential features should be assigned more weights due to closer distances.

The second criterion is similar to the first one, except that the Euclidean distance is replaced by Pearson correlation coefficients. The weights following this criterion are calculated according to the following equation:

$${β}_{k} = \frac{Correlation ( k )}{{\sum }_{all k} Correlation ( k )} ,$$

wherein Correlation(k) denotes the Pearson correlation coefficient between the feature k of the source under consideration and the known effort. The Pearson correlation coefficient measures how variables or rank orders are related, and if the correlation coefficient of a feature is significant, the feature and the known effort should exhibit a perfect relation. Hence, this feature should be assigned a higher weight than less correlative features.

The third criterion is to assign the weights according to the linear relation between the known effort of the source software and the features of the source under consideration. The weights following this criterion are calculated according to the following equation:

$${β}_{k} = \frac{{a}_{k}}{{\sum }_{all k} {a}_{k}} ,$$

wherein aₖ denotes the coefficient corresponding to the feature k, and the linear relation is described as follows:

$$X ( Dep ) = {\sum }_{k = 1}^{M} {a}_{k} X ( k ) + c ,$$

wherein M is the total number of features, and c is a constant. This linear relation fits data points onto a straight line by maximizing the likelihood function or equivalently minimizing the least squared errors (LSE).

The fourth criterion is to assign the weights according to the nonlinear relation between the known effort of the source software and the features of the source under consideration. The weights following this criterion are calculated according to the following equation:

$${β}_{k} = \frac{{a}_{k}}{{\sum }_{all k} {a}_{k}} ,$$

and the nonlinear relation is described as follows:

$$X ( Dep ) = {\sum }_{k = 1}^{M} {a}_{k} {X ( k )}^{b} + c ,$$

wherein b is an exponent. This nonlinear relationship adjusts the independent variables more dramatically than the linear relationship due to the use of the exponent.

The fifth criterion is to assign the weights according to the most similar features of the software to be developed and the source softwares. That is, only the most similar features will be assigned weight. Those features whose similarities are smaller would be assigned the weight zero. The weights following this criterion are calculated according to the following equation:

$${β}_{k} = \{ \begin{matrix}1 , & if γ ( {X}_{0} ( k ) , {X}_{i} ( k ) ) = {max}^{∀ k , i} ( γ ( {X}_{0} ( k ) , {X}_{i} ( k ) ) ) \\ 0 , & otherwise .\end{matrix}$$

Table 1 shows the improvement percentage of the weighted GRA over the non-weighted GRA with same group of data. DW represents the first criterion; CW represents the second criterion; LW represents the third criterion; NLW represents the fourth criterion; MW represents the fifth criterion. Keremer, COCOMO, and ISBSG represent three data sets.

TABLE 1
Improvement in weighted GRA over non-weighted GRA

| | DW | CW | LW | NLW | MW |
|---|---|---|---|---|---|
| Kemerer | 8.61% | 11.23% | 10.3% | 10.3% | 10.3% |
| COCOMO | 8.6% | 13.92% | 22.78% | 14.43% | −55.57% |
| ISBSG | 2.69% | 2.69% | 4.94% | 4.94% | 4.94% |

Note that almost every criterion over the three data sets has some improvement, except for the fifth criterion under the COCOMO data set. That is because that the fifth criterion is not stable in some cases. Nevertheless, in other cases it still shows some improvement.

In conclusion, the weighted GRA method of the present invention not only utilizes the efficient GRA method, which is seldom seen in the application of software development effort estimation, but also adapts weighted similarity into the application. Thus, the present invention provides a novel and efficient method for estimating the software development effort, which significantly improves the accuracy of the estimating process.

The above-described embodiments of the present invention are intended to be illustrative only. Those skilled in the art may devise numerous alternative embodiments without departing from the scope of the following claims.

What is claimed is:

1. A method for estimating software development effort, the software to be developed exhibiting a plurality of features, the method comprising the steps of:
generating a database containing a plurality of source softwares, wherein each source software exhibits a plurality of features;
calculating Grey relational coefficients representing similarity between the features of the software to be developed and one source software exhibiting a specific feature;
calculating a weight for each Grey relational coefficient;
calculating Grey relational grades each by summing up the product of each Grey relational coefficient multiplying the corresponding weight, wherein the Grey relational grade represents the similarity between the software to be developed and the source software; and
comparing the Grey relational grades to estimate the effort for developing the software to be developed.

2. The method of claim 1 for estimating software development effort, wherein the Grey relational coefficients are calculated according to the following equation:
$$γ ( {X}_{0} ( k ) , {X}_{i} ( k ) ) = \frac{min {Δ}_{0 i} + ζmax {Δ}_{0 i}}{{Δ}_{0 i} ( k ) + {ζmaxΔ}_{0 i}} ,$$
wherein X₀ denotes the software to be developed, Xᵢ denotes the source software, γ(X₀(k), Xᵢ(k)) denotes the Grey relational coefficient, ζ denotes a coefficient ranging from 0 to 1, k denotes the specific feature in the Grey relational coefficient, X(k) denotes the value of the feature k, and Δ₀ᵢ(k) is calculated according to the following equation:
$${Δ}_{0 i} ( k ) = \{ \begin{matrix}\vert {X}_{0} ( k ) - {X}_{i} ( k ) \vert , & if {X}_{0} ( k ) and {X}_{i} ( k ) are numericals \\ 1 , & \begin{matrix}if {X}_{0} ( k ) and {X}_{i} ( k ) are categoricals \\ and {X}_{0} ( k ) \neq {X}_{i} ( k )\end{matrix} \\ 0 , & \begin{matrix}if {X}_{0} ( k ) and {X}_{i} ( k ) are categoricals \\ and {X}_{0} ( k ) = {X}_{i} ( k ) ,\end{matrix}\end{matrix}$$
wherein min Δ₀ᵢ is calculated as
$$min {Δ}_{0 i} = {∀}^{min} i {∀}^{min} k \vert {X}_{o} ( k ) - {X}_{i} ( k ) \vert ,$$
and max Δ₀ᵢ is calculated as
$$max {Δ}_{0 i} = {∀}^{max} i {∀}^{max} k \vert {X}_{o} ( k ) - {X}_{i} ( k ) \vert .$$

3. The method of claim 1 for estimating software development effort, wherein the Grey relational grade is calculated according to the following equation:
$${Γ}_{0 i} = {\sum }_{k = 1}^{M} {β}_{k } γ ( {X}_{o} ( k ) , {X}_{i} ( k ) ) ,$$
wherein Γ₀ᵢ denotes the Grey relational grade, X₀ denotes the software to be developed, Xᵢ denotes the source software, γ(X₀(k), Xᵢ(k)) denotes the Grey relational coefficient, k denotes the feature in the Grey relational coefficient, βₖ denotes the weight corresponding to the feature k, and M is the total number of features.

4. The method of claim 1 for estimating software development effort, wherein the weight is calculated according to the dissimilarity between the feature under consideration and a known effort.

5. The method of claim 4 for estimating software development effort, wherein the weight is calculated according to the following equation:
$${β}_{k} = \frac{\frac{1}{Distance ( k )}}{{\sum }_{all k} \frac{1}{Distance ( k )}} ,$$
wherein k denotes the feature in the Grey relational coefficient, βₖ denotes the weight corresponding to the feature k, and Distance(k) is determined as follows:
$$Distance ( k ) = \sqrt{{\sum }_{i = 1}^{N} {( {X}_{i} ( k ) - {X}_{i} ( Dep ) )}^{2}} ,$$
wherein N denotes the total number of source softwares in the database, Xᵢ denotes the source software, X(k) denotes the value of the feature k, and X(Dep) denotes the known effort.

6. The method of claim 1 for estimating software development effort, wherein the weight is calculated according to a Pearson correlation coefficient between the feature under consideration and a known effort.

7. The method of claim 6 for estimating software development effort, wherein the weight is calculated according to the following equation:
$${β}_{k} = \frac{Correlation ( k )}{{\sum }_{all k} Correlation ( k )} ,$$
wherein k denotes the feature of the Grey relational coefficient, βₖ denotes the weight corresponding to the feature k, and Correlation(k) denotes the Pearson correlation coefficient between the feature k of the source software under consideration and the known effort.

8. The method of claim 1 for estimating software development effort, wherein the weight is calculated according to a linear relation between a known effort of the source software and the features of the source software under consideration.

9. The method of claim 8 for estimating software development effort, wherein the weight is calculated according to the following equation:
$${β}_{k} = \frac{{a}_{k}}{{\sum }_{all k} {a}_{k}} ,$$
wherein k denotes the feature in the Grey relational coefficient, βₖ denotes the weight corresponding to the feature k, aₖ denotes the coefficient corresponding to the feature k, and the linear relation is described as follows:
$$X ( Dep ) = {\sum }_{k = 1}^{M} {a}_{k} X ( k ) + c ,$$
wherein X(Dep) denotes the known effort, X(k) denotes the value of the feature k, M is the total number of the features, and c is a constant.

10. The method of claim 1 for estimating software development effort, wherein the weight is calculated according to a nonlinear relation between a known effort of the source software and the features of the source software under consideration.

11. The method of claim 10 for estimating software development effort, wherein the weight is calculated according to the following equation:
$${β}_{k} = \frac{{a}_{k}}{{\sum }_{all k} {a}_{k}} ,$$
wherein k denotes the feature in the Grey relational coefficient, βₖ denotes the weight corresponding to the feature k, aₖ denotes the coefficient corresponding to the feature k, and the nonlinear relation is described as follows:
$$X ( Dep ) = {\sum }_{k = 1}^{M} {a}_{k} {X ( k )}^{b} + c ,$$
wherein X(Dep) denotes the known effort of the source software, X(k) denotes the value of the feature k, M is the total number of features, b is an exponent, and c is a constant.

12. The method of claim 1 for estimating software development effort, wherein the weight is calculated according to the most similar features of the software to be developed and the source softwares.

13. The method of claim 12 for estimating software development effort, wherein the weight is calculated according to the following equation:
$${β}_{k} = \{ \begin{matrix}1 , & if γ ( {X}_{0} ( k ) , {X}_{i} ( k ) ) = {max}^{∀ k , i} ( γ ( {X}_{0} ( k ) , {X}_{i} ( k ) ) ) \\ 0 , & otherwise\end{matrix}$$
, wherein k denotes the feature in the Grey relational coefficient, βₖ denotes the weight corresponding to the feature k, X₀ denotes the software to be developed, Xᵢ denotes the source software, X(k) denotes the value of the feature k, and γ(X₀(k), Xᵢ(k)) denotes the Grey relational coefficient.

14. The method of claim 1 for estimating software development effort, wherein the source software with the highest Grey relational grade represents the software most similar to the software to be developed.
